(19) United States
(12) Patent Application Publication
(10) Pub. No.: US 2014/0339160 A1
(43) Pub. Date: Nov. 20, 2014

(54) METHOD, APPARATUS AND KIT FOR THE EXTRACTION OF LIPID-SOLUBLE COMPOUNDS

(71) Applicant: Certo Labs, Inc., Toronto (CA)

(72) Inventors: Flaviu Ciobanu, Toronto (CA); Ameer Y. Taha, Toronto (CA); Adam Henry Metherel, Waterloo (CA); Kenneth Douglas Stark, Waterloo (CA)

(21) Appl. No.: 14/345,541

(22) PCT Filed: Sep. 19, 2012
(86) PCT No.: PCT/CA2012/050652

§ 371 Date: Mar. 18, 2014

Related U.S. Application Data
(60) Provisional application No. 61/536,330, filed on Sep. 19, 2011.

(51) Int. Cl. B01D 11/04; A23L 1/015; C02F 1/26; B01D 35/02

(52) U.S. Cl. CPC B01D 11/04; B01D 35/02; A23L 1/0152; C02F 1/26
USPC 210/634; 210/799; 210/435; 210/416.1

(57) ABSTRACT

A method of separating an aqueous portion from a heterogeneous sample containing said aqueous portion and a non-aqueous (lipid) portion, teaches passing a sample through glass wool, thus trapping the aqueous layer in the glass wool and eluting the lipid layer from the glass wool.

This application claims priority to and the benefit of U.S. Provisional Patent Application No. 61/536,330 filed Sep. 19, 2011, the contents of which are incorporated herein by reference.

### FIELD OF THE INVENTION

The present invention relates to an extracting method for lipid-soluble compounds such as fatty acids, sterols, and triazine pesticides from samples, and an extraction kit. More particularly, it relates to a method of extracting lipids, fatty acids, sterols and triazine pesticides easily and efficiently, and an extraction kit used therefore.

### BACKGROUND OF THE INVENTION

The consumption of nutrients such as dietary fat has significant consequences on human health. For example, omega-3 polyunsaturated fatty acids, such as eicosapentaenoic acid (EPA) and docosahexaenoic acid (DHA) are may provide significant cardiovascular benefits, support optimal neurological development, and protect against various neurological disorders, including depression, Alzheimer's disease and attention deficit disorder. Other dietary fats have significant negative effects—for example, industrially generated so-called trans fatty acids, saturated fats and cholesterol are believed to dramatically increase the risk of cardiovascular disease and the risk of death associated with them.

Similarly, the contamination of food samples with drugs or toxins is associated with cancer, teratogenesis, liver failure and metabolic syndrome. Often, these drugs or toxins are trapped within the lipid-dense compartments of foods and tissues.

Constant and accurate monitoring of the food supply is therefore crucial, and often requires extraction of lipids from a heterogeneous food sample. This extraction can be used to determine the amount, or percentage, of lipid in a given sample, the type of lipid(s) present in a given sample, or to further characterize the impurities, such as toxins or drugs, found within that lipid component. Extraction of lipids is desirable from a variety of samples, including food samples, and tissue samples.

Current analytical methods for the extraction of lipids from a sample are expensive and time-consuming. Techniques include direct extraction with various solvents, heating, pressure waves generated by electric arcs, direct saponification via KOH and ethanol, sonication, freezing and grinding, and bead mills. Other methods include pressure disruption, enzymatic extraction, treatment with a polar organic solvent, salt, or precipitating agent, temperature and/or pressure changes, binding of specific analytes that trigger color changes, and direct extraction/separation detection methods such as liquid chromatography, gas chromatography supercritical fluid chromatography, immunoassay methods, and radiolabelling assays.

There are several currently acceptable protocols used by industry, universities, and research institutions for the extraction and quantification of total lipids containing fatty acids from food samples. For instance, protocols approved by the Association of Official Analytical Chemists (AOAC Official Method 996.06 (2005) Official Methods of Analysis of AOAC International, 18th ed. AOAC International, Gaithersburg) or the International Organization for Standardization method (ISO) (Luque-Garcia JL, Luque de Castro MD (2004) Ultrasound-assisted soxhlet extraction: an expeditive approach for solid sample treatment. Application to the extraction of total fat from oleaginous seeds. J. Chromatogr A 1034:237-242) are typically used by industry laboratories to determine analyte/compound composition of food, animal tissue, soil and biological fluids. The Folch method (Folch J, Lees M, Sloane S G H. A simple method for the isolation and purification of total lipids from animal tissues J. Biol. Chem 1957, 226 (1), 497-509.), another standard, time-tested method developed in 1957 for the extraction of lipids, is still the standard within most research institutions and universities.

Unfortunately, these standardized methods are expensive and onerous, requiring approximately 4-14 hours to complete the extraction component of analysis. The expense comes both from this time requirement, and the large solvent volumes required to perform the extractions (for the ISO and AOAC methods).

One prior art method for the extraction of phenols (Ahn Y G, Shin J H, Kim H Y, Khim J, Lee M K, Hong J (2007) Application of solid-phase extraction coupled with freezing-lipid filtration clean-up for the determination of endocrine-disrupting phenols in fish. Anal Chim Acta 603:67-75), ginsenosides(Wu J, Lin L, Chau F T (2001) Ultrasound-assisted extraction of ginseng saponins from ginseng roots and cultured ginseng cells. Ultrason. Sonochem 8:347-352), anthraquinones (Hemwimol S, Pavasant P, Shotipruk (2006) Ultrasound-assisted extraction of anthraquinones from roots of morinda citrifolia. Ultrason Sonochem 13:543-548), and polycyclic aromatic hydrocarbons (Christensen A, Ostman C, Westerholm R (2005) Ultrasound-assisted extraction and on-line LC-GC-MS for determination fo polycyclic aromatic hydrocarbons (PAH) in urban dust and diesel particulate matter. Anal Bioanal Chem 381:1206-1216) (Richter P, Jimenez M, Salazar R, Marican A (2006) Ultrasound-assisted pressurized solvent extratction for aliphatic and polycyclic aromatic hydrocarbons from soils. J. Chromatogr A, 1132:15-20), as well as fatty acids and other lipids (US patent publication 2006/0099693; 2006/0218668; 2005/0170479), involves the use of ultrasonic energy. Though these ultrasound-assisted lipid extraction methods decrease the sample extraction time, sometimes to as low as one hour (Luque-Garcia JL, Luque de Castro MD (2004) Ultrasound-assisted soxhlet extraction: an expeditive approach for solid sample treatment. Application to the extraction of total fat from oleaginous seeds. J. Chromatogr A 1034:237-242), (Ruiz-Jimines J, Priego-Capote F, Luque de Castro MD (2004) Identification and quantification of trans fatty acids in bakery products by gas chromatography-mass spectrometry after dynamic ultrasound-assisted extraction. J. Chromatogr A 1045:203-210), (Wei F, Gao G Z, Wang X F, Dong XY, Li P P, Hua W, Wang X, Wu X M, Chen H (2008) Quantitative determination fo oil content in small quantity of oilseed rape by ultrasound-assisted extraction combined with gas chromatography. Ultrason Sonochem 15:938-942), Cravotto G, Boffa L, Mantegna S, Perego P, Avogadro M, Cintas P (2008) Improved extraction fo vegetable oils under high-intensity ultrasound and/or microwaves. Ultrason Sonochem 15:898-902), these methods require large sample and solvent volumes. Cravotto et al. (Wei F, Gao G Z, Wang XF, Dong X Y, Li P P, Hua W, Wang X, Wu X M, Chen H (2008) Quantitative determination fo oil content in small quantity of oilseed rape by ultrasound-assisted extraction combined with gas chromatography. Ultrason Sonochem 15:938-942) also examined ultrasound-assisted extraction with small volumes of sample and solvents, but this resulted in determinations of fatty acid content that was qualitative and not quantitative, making it difficult to evaluate the utility of such methods for extracting fatty acids from samples.

A Standard Operating Procedure manual for the U.S. Geological Survey on the Extraction and lipid separation of fish samples (SOP No. HC521A) teaches the use of gas chromatography or gas chromatography/mass spectrometry, using petroleum ether and ethyl acetate for extraction. This is a long and arduous process.

Other methods of extracting fats and lipid-soluble compounds are described in US patent publications 2009/0081344 and 2009/0214734. Automated fat extraction systems are known, and include the Soxhlet extraction technique such as the Soxtec 2055 Fat Extraction System (Foss, Hilleroed, D K).

All these methods typically involve the application of some form of external energy, such as high temperature, pressure and ultrasound, in order to disrupt the tissue in a way that releases trapped compounds. Alternatively, multiple solvent extractions may be used in order to achieve high yields.

Regardless, even with these rapid methods, the process remains tedious and time-consuming due to several rate-limiting steps, such as centrifugation to separate solvent phases, followed by pipetting to physically separate the desired lipid-soluble phase containing lipid-soluble compounds for further processing or analysis.

It would be desirable to have a less expensive and/or more rapid method for the extraction and/or quantitative extraction and/or determination of lipid in a sample, such as a food sample with minimum application of external energy and/or solvent extraction rounds, and with minimum requirement for post-extraction centrifugation and pipetting.

### BRIEF DESCRIPTION OF FIGURES

FIG. 1 shows a separation syringe of the present invention.

### SUMMARY OF INVENTION

According to one aspect of the invention is provided a method of separating an aqueous portion from a heterogenous sample containing the aqueous portion and a non-aqueous (lipid) portion, comprising passing the sample through glass wool, thus trapping the aqueous layer in the glass wool and eluting the lipid layer from the glass wool.

According to another aspect of the invention is provided the use of glass wool filtration to separate an aqueous portion from a non-aqueous (lipid) portion of a heterogeneous sample.

According to a further aspect of the invention is provided an extraction method for separating lipids, fatty acids, cholesterol, pesticides and other lipid-trapped impurities from a sample, comprising: homogenizing the sample in a solvent having a lipophilic and aqueous component to form a homogenized mixture; and adding the homogenized mixture to a top portion of a container. The container has a top portion, a bottom portion, and a central portion, the bottom portion having an aperture through which liquids can flow, the top portion having an opening into which the homogenized mixture can be added, and the central portion containing a quantity of glass wool. Downward pressure is provided to the top portion of the container such that a portion of the homogenized mixture is displaced through the glass wool and out of the aperture; the downward pressure being applied with sufficient force and for a sufficient length of time so that the portion of the homogenized mixture displaced contains a substantial portion of the lipophilic, non-aqueous component of the solvent. The component also now containing the lipids, fatty acids, cholesterol and lipid trapped impurities from the sample, and an absence of a substantial portion of an aqueous portion of the homogenized mixture.

According to certain embodiments, the container is a syringe and the downward pressure is applied using a syringe plunger.

According to certain embodiments, the container is a syringe and the downward pressure is applied through a suction force by way of a vacuum at the exit channel of the syringe.

According to certain embodiments, the solvent is a 2:1 or 3:1 (v:v) chloroform/methanol solution.

According to certain embodiments, the solvent is acetonitrile or another organic , non-aqueous solvent.

According to certain embodiments, the lipid-trapped impurities are a drug.

According to certain embodiments, the lipid-trapped impurities are a toxin.

According to certain embodiments, the lipid-trapped impurities are a triazine pesticide.

According to yet further embodiments, the triazine pesticide is selected from ametryn, atrazine, prometon, prometryn, propazine, simazine, and terbutryn.

According to certain embodiments, the quantity of glass wool is about 420-600 mg, and the container has a volume of 10 ml.

According to certain embodiments, the quantity of glass wool is about 1.5 g and the container has a volume of 50 ml, or 400-600 mg of glass wool in 10 ml syringe.

According to certain embodiments, the quantity of glass wool is about 2.5 g and the container has a volume of 50 ml.

In certain embodiments the glass wool is compressed and/or acid treated.

In certain embodiments, the diameter of the container is about 15-35 mm.

In certain embodiments, the diameter of the aperture is about 3 mm.

In certain embodiments, the sample is a food.

In certain embodiments, the sample is a biological specimen, for example, a tissue, a soil, or an algae.

In certain embodiments, the method further comprises the addition of a buffer or salt solution to the sample and agitating, before adding the homogenized mixture to the top portion of the container. The buffer may be, for example, sodium phosphate buffer or an aqueous solvent that creates a separation gradient.

According to a further aspect of the invention is provided an apparatus for performing the extraction of lipids, fatty acids, cholesterol, pesticides and other lipid-soluble compounds and/or impurities from a sample, the apparatus comprising: a container having a top portion, a bottom portion, and a central portion, the bottom portion having an aperture through which liquids can flow, the top portion having an opening into which the homogenized mixture can be added; wherein the central portion contains a quantity of glass wool.

In certain embodiments, the container is in the form of a syringe, further comprising a syringe plunger, that, when depressed in the top portion of the container, is able to displace liquids placed within the top portion of the container through the glass wool, and out of the aperture.

In certain embodiments, the apparatus includes an instrument that robotically or mechanically applies a specific force on the plunger and brings it to a specific level of the syringe, to elute the non-aqueous solvent containing lipid-soluble compounds.

In certain embodiments, the apparatus includes an instrument that applies a specific suction force by way of a vacuum at the exit channel of the syringe, to elute the non-aqueous solvent containing lipid-soluble compounds.

According to a further aspect of the invention is provided a kit for the extraction of lipids, fatty acids, cholesterol, and lipid trapped impurities from a sample, comprising: the apparatus as hereinbefore described; a buffer or salt solution; a solvent having a lipophilic and aqueous component; and instructions. The instructions comprise the steps of (1) adding the solvent to a sample from which the lipids, fatty acids, cholesterol, and lipid trapped impurities are to be extracted; (2) homogenizing the sample; (3) adding the buffer or salt solution, either before or after step (2); placing the resultant solution into the apparatus of claims 17; and (4) displacing the lipophilic, non-aqueous component containing the lipids, fatty acids, cholesterol and lipid trapped impurities with additional solvent.

### DETAILED DESCRIPTION

The present inventors have found a new method for extracting lipids, fatty acids, cholesterol, and lipid-soluble toxins/drugs from a homogeneous food sample. The new method provides significant time and cost reduction over the prior art methods while maintaining similar or better precision. Since the new method is automated, extraction processes are enabled, using the new method. The present inventors also disclose an apparatus and kit for application of the new method for standardized, and optionally automated and high throughput, lipid extraction.

The lipid extraction is done using homogenization in a solvent having a lipophilic, non-aqueous component, such as chloroform/methanol. In the Folch method, the food or tissue sample is homogenized in a 2:1 (v:v) chloroform/methanol solution 20 times the volume of the tissue sample. The sample is then washed with water, a salt solution, and/or a sodium phosphate buffer. The mixture is agitated in an orbital shaker or vortexed, and the homogenate is either filtrated or centrifuged (for example, at 3000 rpm for 5-20 minutes). The separated bottom, chloroform layer is then extracted. An additional amount of chloroform can be added to the sample, followed by repetition of the agitation and filtration/centrifugation step. The separated chloroform layer is again extracted and pooled with the initial extract. The isolated chloroform layer is evaporated under vacuum or nitrogen; the lipids are found within that layer. The Folch method isolates fatty acids, sterols, and triazine pesticides from samples such as food or tissue samples.

The present inventors have found that the extraction of lipid-soluble compounds from organic solvents such chloroform/methanol, post-homogenization, can be performed much more quickly, just as accurately, and in a desirable, one step extraction, by trapping the aqueous phase and eluting the organic solvent layer containing the lipid-soluble compounds using glass wool, for example, packed in a syringe, then extracting or eluting the lipids from the glass wool utilizing a wash in a lipophilic, non-aqueous solvent such as chloroform. Preferably, the glass wool is acid treated glass wool; such acid treatment degrades most or all contaminating lipids on the glass wool; the extraction can take place in the bottom of a syringe or test tube having a hole in its bottom, for example, a modified eppendorfTM syringe. Without being limited to any specific theory, the glass wool is thought to serve as a filter for large cellular debris, and to retain the aqueous solvents. Lipids/fat-soluble compounds elute from the system with the assistance of an additional organic solvent wash.

### EXAMPLE 1

### Lipid Extraction and Quantification with Folch Method (Prior Art)

0.5 g of frozen tissue was weighed out on weighing paper, in a calibrated balance. The tissue was transferred to a 16 mm pyrex test tube, and 3 ml of 2:1 chloroform/methanol solution was added to the sample. The sample was homogenized for approximately 1 minute, until the sample was visually homogeneous. The test tube was then capped, and the sample vortexed for up to 60 seconds using a desktop vortexer.

500 μl sodium phosphate buffer was added; the tube was then inverted twice or otherwise vortexed for an additional 10 seconds, then centrifuged (3000 rpm, 5 minutes). The bottom, chloroform containing layer of liquid was pipette out of the test tube, and placed in a new, clean test tube. 2 ml of chloroform was added to the original tube, which was then vortexed for about 10 seconds, then centrifuged at 3000 rpm for 5 minutes. Again, the bottom, chloroform containing layer of liquid was added to the second test tube.

The chloroform was evaporated under nitrogen, leaving the lipids from the sample, including any fatty acids, sterols, and triazine pesticides that might have been in the sample. The amount of fatty acid and cholesterol was measured using standard gas chromatographic techniques and/or standard liquid chromatographic and mass spectrographic techniques.

### EXAMPLE 2

### Preparation of a Separation Syringe

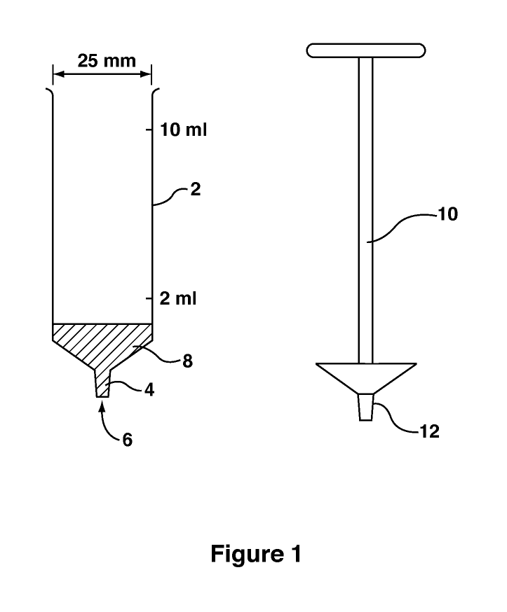

A separation syringe was prepared, as follows, and as illustrated in FIG. 1. An eppendorf® 10 ml Multipette® Plus repeater pipette syringe 2 was modified to shorten the tip 4 to approximately 15 mm, resulting in an opening 6 with a diameter of approximately 3 mm. A corresponding modification (shortening) was also made to the tip 12 of the inner plunger 10. The modifications allows for better and more quantifiable results. The repeater pipette syringe 2 was then filled with approximately 420 mg of acid treated glass wool 8 (Sigma). The use of acid treatment is thought to be advantageous to break down and remove possible lipid contaminants on the glass wool, although the wool itself can perform the separation of the lipid soluble phase from the aqueous layer without acid treatment. Note that, although most experiments were performed with about 420 mg of glass wool, higher amounts of glass wool, for example, 500-600 mg were also suitable, and in fact had higher desirability for more fool-proof protection—with these higher amounts of glass wool, the inventors found that there was less risk of elution of the unwanted, trapped, aqueous layer when the plunger was depressed. The glass wool 8 was compressed in the repeater pipette syringe, using the inner plunger, to approximately the 2 ml marking on the side of the repeater pipette syringe.

The result was a separation syringe 2 having the dimensions as described in FIG. 1, containing approximately 420 mg of acid treated glass wool 8.

### EXAMPLE 3

### Lipid Extraction and Quantification by Glass Wool Extraction

0.5 g of frozen tissue was weighed out on weighing paper, in a calibrated balance. The tissue was transferred to a 16 mm pyrex test tube, and 3 ml of 2:1 chloroform/methanol was added to the sample. The sample was homogenized for approximately 1 minute, until the sample was visually homogeneous. The test tube was then capped, and the sample vortexed for approximately 1 minute using a desk top vortexer.

500 μl sodium phosphate buffer was added; the tube was then inverted twice (although vortexing for about 5-10 seconds was also suitable). The entire contents of the tube were then transferred quickly into a separation syringe 2 prepared as described in Example 2.

2 ml of chloroform was then added to the test tube (as a wash step), which was then vortexed for an additional 10 seconds. The entire contents of the tube were then again transferred quickly into the separation syringe 2. At this point, solvent was observed to pour out of the opening 6 at the bottom of the separation syringe 2; this solvent was collected. This step may be repeated one or several more times as necessary, if yield improvement is needed.

The separation syringe plunger 10 was then placed in the syringe 2, and depressed until approximately the 1 cc mark on the syringe 2, or as far as reasonably possible with normal effort, or until the first signs of an aqueous phase being displaced from opening 6. Solvent displaced from the bottom of the separation syringe was collected and added to the solvent previously collected.

The extracted solvent was evaporated under vacuum, leaving the lipids from the sample, including any fatty acids, sterols, and traizine pesticides that might have been in the sample. The amount of fatty acid and cholesterol was measured using standard gas chromatographic techniques and/or standard liquid chromatographic and mass spectrographic techniques

Compared to the standard Folch method, similar fatty acid and cholesterol concentrations were obtained, with lower variation using the novel method, in both liver and egg samples. Results for liver total fatty acids and egg cholesterol samples were tabulated in Table 1, below. Results for brain total fatty acids and brain fatty acid composition are tabulated in Table 2, below

TABLE 1
Fatty acid and cholesterol concentration for egg samples

| | Fatty acid | Cholesterol |
|---|---|---|
| | concentration | concentration |
| Method | in rat liver | in eggs |
| Folch (Ex. 1) | 31.5 ± 0.3 mg/g | 4.18 ± 0.07 mg/g |
| Glass Wool Extraction | 31.2 ± 0.02 mg/g | 4.20 ± 0.02 mg/g |

TABLE 2
Fatty acid concentrations (mg/g wet weight) in rat brain tissue
following extraction with the conventional Folch or novel kit method.
CONCENTRATION (MG/G)

| | Conventional Folch | Kit method | |
|---|---|---|---|
| Name | Mean ± SD | Mean ± SD | T-Test |
| C 10:0 | 0.007 ± 0.000 | 0.008 ± 0.001 | 0.118903 |
| C 12:0 | 0.050 ± 0.001 | 0.054 ± 0.002 | 0.005803 |
| C 14:0 | 0.297 ± 0.020 | 0.295 ± 0.023 | 0.870496 |
| C 16:0 | 6.744 ± 0.100 | 6.798 ± 0.146 | 0.514684 |
| C 16:0 dma | 0.277 ± 0.039 | 0.282 ± 0.047 | 0.863606 |
| C 18:0 | 6.201 ± 0.059 | 6.346 ± 0.098 | 0.021898 |
| C 18:0 dma | 0.343 ± 0.063 | 0.352 ± 0.076 | 0.852838 |
| C 20:0 | 0.126 ± 0.003 | 0.129 ± 0.002 | 0.117297 |
| C 22:0 | 0.128 ± 0.005 | 0.132 ± 0.003 | 0.127424 |
| C 23:0 | 0.043 ± 0.002 | 0.046 ± 0.001 | 0.018091 |
| C 24:0 | 0.272 ± 0.010 | 0.279 ± 0.008 | 0.258813 |
| SFAs | 14.488 ± 0.202 | 14.721 ± 0.277 | 0.167458 |
| C 12:1 | 0.002 ± 0.000 | 0.002 ± 0.000 | 0.02023 |
| C 14:1 | 0.001 ± 0.000 | 0.001 ± 0.000 | 0.04799 |
| C 16:1 | 0.109 ± 0.006 | 0.104 ± 0.006 | 0.203612 |
| C 18:1 dma | 0.125 ± 0.023 | 0.129 ± 0.026 | 0.794319 |
| C 18:1n-7 | 1.092 ± 0.018 | 1.100 ± 0.025 | 0.614724 |
| C 18:1n-9 | 5.127 ± 0.068 | 5.185 ± 0.107 | 0.332803 |
| C 20:1n-9 | 0.420 ± 0.006 | 0.431 ± 0.013 | 0.135106 |
| C 22:1n-9 | 0.048 ± 0.002 | 0.054 ± 0.003 | 0.00642 |
| C 24:1n-9 | 0.294 ± 0.047 | 0.318 ± 0.016 | 0.291277 |
| MUFAs | 7.217 ± 0.105 | 7.324 ± 0.152 | 0.229406 |
| C 18:2n-6 | 0.239 ± 0.004 | 0.241 ± 0.009 | 0.663959 |
| C 18:3n-6 | 0.001 ± 0.000 | 0.001 ± 0.000 | 0.659943 |
| C 20:2n-6 | 0.045 ± 0.002 | 0.048 ± 0.002 | 0.114091 |
| C 20:3n-6 | 0.107 ± 0.002 | 0.110 ± 0.003 | 0.162328 |
| C 20:4n-6 | 2.941 ± 0.018 | 2.976 ± 0.054 | 0.211332 |
| C 22:2n-6 | 0.008 ± 0.001 | 0.009 ± 0.001 | 0.051121 |
| C 22:4n-6 | 0.873 ± 0.011 | 0.887 ± 0.014 | 0.126419 |
| C 22:5n-6 | 0.153 ± 0.004 | 0.158 ± 0.004 | 0.085969 |
| N-6 | 4.368 ± 0.021 | 4.430 ± 0.084 | 0.148841 |
| C 18:3n-3 | 0.005 ± 0.000 | 0.006 ± 0.001 | 0.141763 |
| C 20:3n-3 | 0.006 ± 0.001 | 0.003 ± 0.001 | 0.004727 |
| C 20:5n-3 | 0.006 ± 0.002 | 0.006 ± 0.001 | 0.829857 |
| C 22:5n-3 | 0.049 ± 0.001 | 0.051 ± 0.001 | 0.021014 |
| C 22:6n-3 | 3.993 ± 0.017 | 4.047 ± 0.069 | 0.125006 |
| N-3 | 4.059 ± 0.020 | 4.113 ± 0.068 | 0.122497 |
| PUFAs | 8.427 ± 0.039 | 8.543 ± 0.151 | 0.132891 |
| HUFAs | 8.128 ± 0.037 | 8.239 ± 0.142 | 0.129797 |
| EPA + DHA | 3.999 ± 0.018 | 4.053 ± 0.069 | 0.126935 |
| N-6/N-3 | 1.076 ± 0.003 | 1.077 ± 0.005 | 0.810768 |
| HUFA Score | 49.870 ± 0.091 | 49.857 ± 0.106 | 0.834309 |
| Total | 30.131 ± 0.316 | 30.588 ± 0.559 | 0.150229 |

PUFAs, polyunsaturated fatty acids;
HUFAs, highly unsaturated fatty acids;
EPA, eicosapentaneoic acid,
DHA, docosahexaenoic acid

### EXAMPLE 4

### Quantification of Pesticides in Tissue/Food Samples

Quantification of pesticides was also performed, for seven known pesticides, and compared to the standard QuEChERS method, which, similar to the Folch, relies on the separation of lipid-soluble solvents containing pesticides from the aqueous layer containing salts and buffers. Samples were prepared by “spiking” 10 g pieces of organic, pesticide free apples with a known amount of pesticide. Briefly, the apples were prepared by cutting two apples into approximately 2 cm squares. The apples were then frozen at -80° C. for 3 hours, and then homogenized in a blender. Dry ice was added to the blender while homogenizing. The result was a coarse powder, which was again frozen at −80° C. 10 g of apple powder was used for each sample.

For control groups (QuEChERS method), to each sample, 9.8 ml of acetonitrile was added, and the sample was shaken vigorously for 30 seconds. 100 μl of a 10pg/pl internal standard (ISTD) solution of Tris-(1,3-dichloroisopropyl)-phosphate was then added. 100 μl of a 5 ng/μl liquid pesticide was added to each sample. The sample was shaken vigorously again for 30 seconds. Buffering salts were added (4 g MgSO4, 1 g NaCl, 1 g trisodium citrate dehydrate, 0.5 g disodium hydrogen citrate sesquihydrate), and the sample was then shaken vigorously again for 60 seconds. The sample was then centrifuged at 3000 g for 5 minutes, and the top layer was removed and placed into a new test tube with 150 mg of PSA and 900 mg MgSO4. The new test tube was shaken vigorously for 60 seconds, and centrifuged at 3000 g for 5 minutes. The top layer was extracted and analyzed by liquid chromatography.

For the Glass wool groups, to each sample, 9.8 ml of acetonitrile was added, and the sample was shaken vigorously for 30 seconds. 100 μl of a 10 μg/μl ISTD solution was then added. 100 μl of a 5 ng/pl liquid pesticide was added to each sample. The sample was shaken vigorously again for 30 seconds. Buffering salts were added (4 g MgSO4, 1 g NaCl, 1 g trisodium citrate dehydrate, 0.5 g disodium hydrogen citrate sesquihydrate), and the sample was then shaken vigorously again for 60 seconds. The entire sample was then added to a separation syringe prepared as described in Example 2, but containing 1.5 g of glass wool and of 50 mL volume, which had been placed in a tube containing 150 mg PSA and 900 mg MgSO4. The plunger was added to the separation syringe and pushed downwards so that approximately 6 ml of acetonitrile was displaced from the separation syringe into the tube containing the PSA and MgSO4. The separation syringe was then removed and the tube (containing the 150 mg PSA, the 900 mg MgSO4, and the acetonitrile portion of the sample) was shaken vigorously for 60 seconds, centrifuged at 3000 g for 5 minutes, and the top layer was extracted and analyzed by liquid chromatography. Notably, other embodiments of the process may benefit from the addition of PSA and MgSO4, or other related reagents/powders to the separation syringe containing the glass wool. Other embodiments may also benefit from the use of capsules containing these reagents/powders, or even the glass wool, while being released with a solvent that breaks the capsule such as an acid.

Results for the two methods were tabulated in Table 3, below. The Glass Wool method provided an accuracy as good as or better than the prior art standard QuEChERS method.

TABLE 3
Pesticide concentrations for known standards

| | Expected | | | Mean | Standard | | |
|---|---|---|---|---|---|---|---|
| Pesticide | Concentration | n | Method | concentration | Deviation | % CV | Accuracy |
| Ametryn | 50.000000 | 18 | Glass wool | 50.515942 | 3.479797 | 6.888513 | 101.031883 |
| | | | QuEChERS | 50.474565 | 3.375183 | 6.686899 | 100.949131 |
| Atrazine | 50.000000 | 18 | Glass wool | 50.986571 | 3.786218 | 7.425911 | 101.973142 |
| | | | QuEChERS | 52.068355 | 6.876431 | 13.206546 | 104.136711 |
| Prometon | 50.000000 | 18 | Glass wool | 50.203478 | 2.870689 | 5.718108 | 100.406956 |
| | | | QuEChERS | 49.560812 | 3.295918 | 6.650251 | 99.121623 |
| Prometryn | 50.000000 | 18 | Glass wool | 50.737181 | 2.830751 | 5.579244 | 101.474363 |
| | | | QuEChERS | 52.253204 | 2.860262 | 5.473850 | 104.506407 |
| Propazine | 50.000000 | 18 | Glass wool | 51.253613 | 3.126480 | 6.100019 | 102.507226 |
| | | | QuEChERS | 50.771262 | 3.440697 | 6.776859 | 101.542523 |
| Simazine | 50.000000 | 18 | Glass wool | 50.625716 | 2.395723 | 4.732225 | 101.251432 |
| | | | QuEChERS | 50.715205 | 4.293877 | 8.466647 | 101.430409 |
| Terbutryn | 50.000000 | 18 | Glass wool | 50.349174 | 2.324610 | 4.616977 | 100.698348 |
| | | | QuEChERS | 51.743111 | 2.272276 | 4.391456 | 103.486222 |

As would be appreciated by a person of skill in the art, the method can be automated, in a multi-sample robotic apparatus which may incorporate one or more of the homogenization, solvent addition and agitation steps, as well as transfer of the sample through glass wool and collection of the lipid portion.

1. A method of separating an aqueous portion from a heterogeneous sample containing said aqueous portion and a non-aqueous (lipid) portion, comprising passing said heterogeneous sample through glass wool, thus trapping the aqueous layer in the glass wool and eluting the lipid layer from the glass wool.

2. (canceled)

3. An extraction method for separating one of more of a lipid-soluble impurity or compound selected from a lipid, fatty acid, cholesterol, pesticide, residue, hormone, vitamin, and other, from a sample, comprising:
homogenizing the sample in a solvent having a lipophilic and aqueous component to form a homogenized mixture;
adding said homogenized mixture to a top portion of a container, said container having a top portion, a bottom portion, and a central portion, said bottom portion having an aperture through which liquids can flow, said top portion having an opening into which said homogenized mixture can be added, and said central portion containing a glass wool;
providing downward pressure to the top portion of the container such that a portion of the homogenized mixture is displaced through said glass wool and out of said aperture;
said downward pressure being applied with sufficient force and for a sufficient length of time so that the portion of the homogenized mixture displaced contains a substantial portion of the lipophilic, non-aqueous component of said solvent, said component also now containing the lipid-soluble impurity or compound from the sample, and an absence of a substantial portion of an aqueous portion of said homogenized mixture.

4. The method of claim 3 wherein the container is a syringe and the downward pressure is applied using a syringe plunger or a force by way of a vacuum at an exit channel of the syringe.

5. (canceled)

6. The method of claim 3 wherein the solvent is a 2:1 or 3:1 (v:v) chloroform/methanol solution.

7. (canceled)

8. The method of claim 3 wherein the lipid-trapped impurity is a drug, a toxin, or a triazine pesticide.

9. (canceled)

10. (canceled)

11. The method of claim 8 wherein the triazine pesticide is selected from ametryn, atrazine, prometon, prometryn, propazine, simazine, and terbutryn.

12. The method of claim 3 wherein the glass wool is about 420-600 mg, and the container has a volume of 10 ml.

13. The method of claim 3 wherein the glass wool is about 1.5 g and the container has a volume of 50 ml.

14. The method of claim 3 wherein the glass wool is about 2.5 g and the container has a volume of 50 ml.

15. The method of claim 3 wherein the glass wool is compressed and/or acid treated.

16. (canceled)

17. The method of claim 3 wherein a diameter of the container is about 15-35 mm and/or the diameter of the aperture is about 3 mm.

18. (canceled)

19. The method of claim 3 wherein the sample is a food or a biological specimen.

20. (canceled)

21. The method of claim 19 wherein the biological specimen is selected from the group consisting of a tissue, a soil, and an algae.

22. The method of claim 3 further comprising the addition of a buffer or salt solution to the sample and agitating, before adding the homogenized mixture to the top portion of the container.

23. The method of claim 22 wherein the buffer is sodium phosphate buffer or an aqueous solvent that creates a separation gradient.

24. An apparatus for performing the extraction of lipids, fatty acids, cholesterol, pesticides and other lipid-soluble compounds and/or impurities from a sample utilizing the method of claim 1, said apparatus comprising: a container having a top portion, a bottom portion, and a central portion, said bottom portion having an aperture through which /liquids can flow, said top portion having an opening into which said homogenized mixture can be added; wherein the central portion contains a glass wool.

25. The apparatus of claim 24 wherein the container is in the form of a syringe, further comprising a syringe plunger, that, when depressed in the top portion of said container, is able to displace liquids placed within the top portion of the container through the glass wool, and out of the aperture.

26. The apparatus of claim 25, comprising an instrument that robotically or mechanically applies a specific force on the plunger and brings it to a specific level of the syringe, or applies vacuum suction, to elute the non-aqueous solvent containing lipid-soluble compounds.

27. A kit for the extraction of lipids, fatty acids, cholesterol, and lipid-soluble trapped impurities from a sample, comprising:
the apparatus of claim 24;
a buffer or salt solution;
a solvent having a lipophilic and aqueous component;
instructions comprising the steps of (1) adding the solvent to a sample from which the lipids, fatty acids, cholesterol, and lipid trapped impurities are to be extracted; (2) homogenizing the sample; (3) adding the buffer or salt solution, either before or after step (2); placing the resultant solution into the apparatus of claim 17; (4) displacing the lipophilic, non-aqueous component containing the lipids, fatty acids, cholesterol and lipid trapped impurities with additional solvent.
